(19) United States
(12) Patent Application Publication
(10) Pub. No.: US 2004/0128292 A1
(43) Pub. Date: Jul. 1, 2004

(54) Search data management

(76) Inventor: Mark Kinnell, Stalybridge (GB)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/692,296

(22) Filed: Oct. 23, 2003

Related U.S. Application Data
(63) Continuation of application No. PCT/GB02/01897, filed on Apr. 26, 2002.

(30) Foreign Application Priority Data
Apr. 27, 2001 (GB) 0110260.7

(51) Int. Cl. G06F 7/00

(52) U.S. Cl. 707/9

(57) ABSTRACT

A method of data management permitting selective access to multiple textual databases by subject or concept comprises a central processing unit or knowledge engine providing access to the multiple databases and having its own linguistic reference database or dictionary including synonyms and statistical analysis software adapted to cooperate in the processing of database access instructions in plain language to achieve a refinement thereof not hitherto available. The linguistic reference database serves also to provide textual coordination and concept/subject identification using algorithms and synonym data for data matching purposes between instructions and data to be retrieved. By complementary textual analysis steps both with respect to the instructions and with respect to the databases to be searched including creation of an index or reference database, concepts can be identified by subject within any given document to be searched.

### CROSS REFERENCE TO RELATED APPLICATIONS

This application is a continuation of International Application No. PCT/GB02/01897 filed Apr. 26, 2002, the disclosure of which is incorporated herein by reference, and which claims priority to Great Britain Patent Application No. 0110260.7 filed Apr. 27, 2001, the disclosure of which is incorporated herein by reference.

### BACKGROUND OF THE INVENTION

This invention relates to search data management and search engine systems and provides a method involving software systems for providing computer-based access to database systems offering accessible stored data and software systems.

### LANGUAGE INTERPRETATION

One key feature for improving access to such systems is the widely accepted need for a facility to offer search functions without prescriptive instructional procedures. There is a great need for users to be provided with the means to instruct or request search and the like functions, as a preliminary to data or software transfer instructions (or indeed as part thereof), wherein the user's own natural choice of language can be used as a basis for such steps with a reasonable prospect of comprehensional success of those search instructions, provided the language used is reasonable in the circumstances and does not require the use of supplemental interrogatories as may be required in the case of person-to-person instructional/request circumstances.

Existing approaches to the provision of free language use in the instructional/request environment have been based upon, in many cases, a statistical approach which enables the computing power of the available data analysis system to be used to good effect on the basis of its undoubted capacity to handle numerical data.

This approach uses as an important part of its method for the comprehension of language, an analysis function in which word meanings are handled on the basis of numerical data.

This approach, though effective to some extent, is inevitably limited by the extent of the optional language variations in which factors nominally “external” to a word including its pronunciation and context (quite apart from slight variations in spelling) may substantially affect its proper interpretation.

Another approach to the long-known question of language interpretation would be linguistically based, in which the computing power of the available data-handling system is used to handle the allocation of textual interpretations on the basis of a stored data base or dictionary of meanings and additional stored data relating to language use, and the use of analysis techniques involving a complex interplay of selected items from this data base, and selection between (often) multiple potentially meaningful combinations of these. Such an approach is nominally less straightforward than the statistical approach and may require greater computing power, though the latter is less of a significant factor than has hitherto been the case.

Analysis of the results of the use of statistical comprehension systems is that useful though they can be there is the need for a modification of the statistical approach which enables it to provide a more reliable approach to the satisfactory comprehension of an instructional request.

In accordance with the broad principles of our research findings and resultant technical advance, this improvement in the statistical approach can be achieved by means of the adoption of a hybrid approach in which the manipulation of available interpretations of words and word groups involves a stage or step, or series of stages or steps, of numerical manipulation, but the allocation of a preferred interpretation to a selected word or group of words is carried out on the basis also of a step or steps in which the available interpretational options are further manipulated (or manipulated on a preliminary basis) utilising a linguistically-based technique in which a non-statistical but language-based analysis is performed in relation to the words and/or word elements as such and on the basis of a stored data base of information relating to relationships between words and word elements and their current usage in the language concerned.

Although the disclosure herein relates to comprehension of the English language so far as the specific examples are concerned, the principles herein are equally applicable to other languages, though these may require substantial revision of the rules and data relating to word and word element relationships, including options relating to pronunciation and emphasis/stress allocated to word elements in the spoken word.

It is to be understood that the present invention is concerned both with comprehension in relation to text as such (derived from a keyboard, for example) as well as text represented in an alternative format including the spoken word, whether in the form of sound as such or recorded and/or transmitted in various ways.

Broadly, aspects of the present invention provide a combination of linguistic and statistical techniques in which there is provided a hybrid approach utilising steps from both statistical language analysis and language analysis as such, the approach adopted comprising a sequence of steps from both approaches providing an interplay of the comprehensional benefits of both procedures, without merely adopting a modification of the rules for manipulation of interpretation merely in one system or the other.

In this way, we have found, it is possible to provide a basis for the manipulation of language, as needed for example in the case of search engines, which has hitherto not been available and offers functions which enable the provision of data and software handling systems hitherto impractical in terms of computing power and/or data processing time and/or user input time requirements.

### DATA CO-ORDINATION

Another important aspect of database accessibility so far as concerns the provision of efficient multiple access for independent users, we have discovered, is the coordination of the instructions which form the basis for the access and data retrieval exercise, and the textual format of the data to be retrieved. In other words distinct advantages can be obtained (we have discovered) in terms of efficiency and access or retrieval if there is a coordination of the data forming and grouping both in relation to the search instructions and in relation to the data itself (or in relation to representative searchable portions thereof).

Thus, we have found that, in relation to textual data to be searched and retrieved from a database, if the data to be searched and retrieved is subdivided into textual subdivisions of graded aggregate data size, and likewise in relation to subject matter then such formatting materially facilitates the data matching and retrieval process.

In relation to the input or search instructions for any given data or software retrieval step there is preferably provided a process comprising a series of data manipulation steps comprising elements common to the following data or software identification and retrieval steps. These common elements include text analysis and text-matching, these steps being modulated by technical subject matter and performed in relation to template blocks of established text provided in the database for reference in relation to the manipulation of plain language instructions and so as to filter and adapt these, whatever their (reasonable) language source, in terms of the skill of the use of the chosen language, so as to produce from all reasonably competently articulated search input instructions, a corresponding set of textual instructions for a data processing unit (which is to effect the search). Those instructions for the data processing unit are (by virtue of the commonality of the steps in the production of those instructions) adapted to be coordinated with the data matching and retrieval steps themselves whereby the latter are performed more expeditiously than would normally be the case (in terms of processing time and matching accuracy and effectiveness).

In terms of the general approach to the provision of commonality in the input search instructions data-processing and the corresponding database data matching and retrieval steps, the following elements are of significance. Firstly, coordination and a degree of commonality in the analysis of text by subject matter. This means that the likelihood of a mismatch in terms of indexing and subdivision of subject matter (which can occur where two randomly-chosen indexing systems are required to cross-refer) are avoided.

Secondly, a related degree of commonality and coordination applies to the reference text database used in relation to processing of the search instructions for the production of processor-instructions, and the corresponding textual reference basis provided in relation to the one or more databases to be searched by the process or unit. Any given database which is to be searched can of course be searched as it stands on the basis of the textual and/or other data stored therein by the database creator. Alternatively, and in accordance with an aspect of the present invention there may be provided additionally a searchable or other reference index, developed by a software programme which establishes links between the index and the corresponding original data for retrieval purposes. This index is in this way coordinated in terms of text and other data utilisation with the corresponding index and reference text used for processing input instructions.

In this way, the above-discussed coordination of the search formulation process and the search implementation steps is achieved with an appreciable enhancement of efficiency and matching accuracy.

A further feature of the process adopted for text handling in relation to both the search formulation and the search implementation stages is the subdivision of text not only by subject matter as discussed above, but also simply on the basis of document sections as adopted by the creator, whereby paragraphs or sections are more readily dealt with as such.

Search disfunctionality or inoperability arising from spelling irregularities (whether of origin in keyboard errors or regional/national differences in language utilisation) are evaluated and reduced in effect if not eliminated by the provision of a spell checking function in relation to search instructions. As a practical means for eliminating or reducing search efficiency reduction we have found that such is of potentially substantial importance as a practical measure for the user. The spell checking function operates on the basis of existing spell checking systems. However, use of such in relation to search instructions as such has not to our knowledge been previously contemplated as a means for such elimination of erroneous search steps.

A further feature of the embodiments relates to the situation where a search enquiry remains unanswered. The software is adapted to cause in such circumstances automatic escalation of the search instruction to a formal record of the search data and question with provision for the entry of additional information and related formal data concerning the user's service agreement as a basis for the work in question. This enables the system to monitor response time and to provide a corresponding lead time for a future response which matches the level of service which the user is entitled to.

In further embodiments the facilitation of the search and data-retrieval function is promoted by the adoption of a database indexing function based upon the creation of a supplemental database created utilising the text and other data from the primary database and processing same in accordance with text-processing parameters including text subdivision into text portions of graduated size, and text classification by subject matter using word group analysis.

The adoption of a virtual database for indexation purposes and created for subject matter retrieval and identification purposes has, we have discovered, significant benefits in terms of the precision of text matching with search instructions. Indeed, our research shows that in the case of databases requiring high rates of user access, the time and therefore cost associated with the creation of the virtual database is well rewarded by the increase in efficiency of subsequent searching.

### SEARCHING BY CONCEPT

An aspect of the invention which is of considerable importance in terms of user satisfaction in relation to search findings concerns presentation of search findings data, and the precision with which such data is able to be presented. For example, it is by no means uncommon that search findings will be presented in terms of mere identification of a document which may contain relevant text or other subject matter, and the user is then left to search for such matter as a subsequent independent step, and such a step is frequently laborious in the extreme when the document in question is relatively substantial in its content.

To meet this need, the embodiments of the present invention provide an index or reference database, which may be termed a virtual database, based upon textual and other matter contained in the original database and which has been subjected to analysis by reference to subject matter by means of a series of steps providing a degree of word sense disambiguation whereby single concepts disclosed in the text are identified together with their location in the text of the original database. By reference to the context in which a word or word set is used, by analysis of the adjacent words and word groups with which it is used, an approach to the sense in which a given word or word set is used can be obtained so as to identify the particular meaning or at least to limit the range of optional meanings which may be ascribed to a given word or word set.

A further approach to the identification of word sense and subject matter concepts is provided by the use of a database dictionary of synonyms and synonym sets, whereby identification of word sense is not prevented by variations in language use as between the instructions and the database.

In this manner a reference or index database can be established based on the textual and other data from the original database and which forms a searchable “virtual” database for subject matter identification and in which the subject matter or concepts are stored in a compact data format, for example by use of minimal numerical data whereby the data storage requirements implicit in storage in textual format are greatly reduced.

By this approach, certain embodiments of the present invention enable the provision of a search system able to respond to search instructions requiring the identification of subject matter concepts, and to achieve this without the usual limitations inherent in language use variability, and indeed to report on the basis of the individual location within the original textual database at which the concept concerned has been found, with an option for screen-display of the original text.

Background art in this field identified in a search includes WO Application No. 98/39714 assigned to Microsoft, U.S. Pat. No. 5,983,221 assigned to Wordstream, and U.S. Pat. No. 5,519,608 assigned to Xerox, all of which are incorporated by reference herein.

According to the invention there is provided a method for data management as defined in the accompanying claims.

### BRIEF DESCRIPTION OF THE DRAWINGS

FIG. 1 shows the input section of the data management system including the speech or text instructions and subsequent functions up to and including the knowledge engine or search engine;

FIG. 2 shows the subsequent portion of the data management system including (shown again) the search or knowledge engine together with its associated databases and the statistical and linguistic database and text analysis functions;

FIG. 3 shows the linguistic database associated with the search or knowledge engine;

FIG. 4 shows the statistical text analysis function which is likewise associated with the search or knowledge engine; and

FIGS. 5 to 7 show in similar format three further aspects and embodiments of the invention.

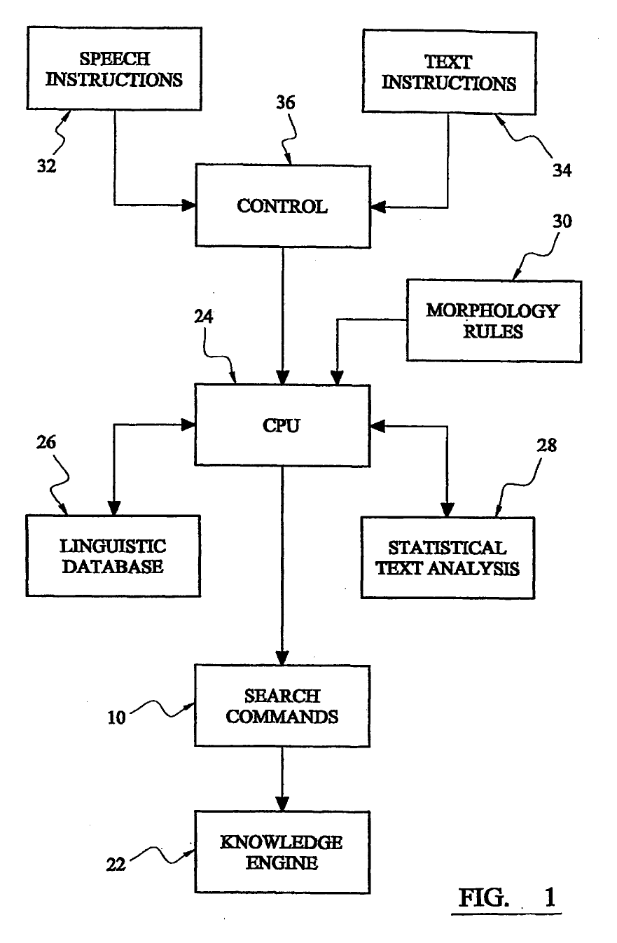

As shown in FIG. 1 a system 10 for data management which permits selective access to a series of databases 12, 14, 16, 18 and 20 (marked DTB1, DTB2, DTB3, DTB4, . . . DTBN), does so by subject and/or data grouping.

### DETAILED DESCRIPTION OF THE INVENTION

Data processing means 22 (identified in FIG. 1 as Knowledge Engine) is provided to give access to the databases 12 to 20.

Additionally, access instruction means 24 (identified in FIG. 1 as CPU) is adapted to permit instructions to be provided to data processing means 22 for such access.

In this embodiment, the data processing means 22 or knowledge engine and the access instruction means 24 (or CPU) are shown separately with identification there between of “search commands”, which will be discussed below. However, it is to be understood that the data processing means and the access instruction means will usually be provided as two functions of a single computer system. There is no significance in the separation or integration of these functions.

Data processing means 22 is adapted to match instructions received from access instruction means 24 with data items stored in databases 12 to 20 to permit matched data items to be identified for retrieval.

However, although many data management systems provide for access to databases via a search engine or data processing means, in this embodiment of the invention the step of causing the access instruction means to instruct the data processing means for such access is accompanied by a step of data processing of the instructions (and a corresponding data processing step performed either then or previously) in relation to the database to be searched (or of a reference portion thereof) to facilitate the matching of the instructions with the relevant data items of the database.

Such data processing of the instructions and of the database to facilitate the m matching step is carried out by the access instruction means 24 (CPU) in association with a linguistic database 26 and a statistical text analysis function 28. These functions operate in relation to the access instruction means 24 in association with a database of morphology rules 30 to process speech instructions 32 or textual instructions 34 (e.g., from a keyboard) which are fed to access instruction means 24 via a control 36 (usually forming part of the computer system of data processing means 22 and access instruction means 24, and which is able to provide instructions in electronic format from either source, using a speech recognition system for processing of speech instructions 32.

The data processing of the instructions and of the database data for such facilitation of matching is carried out by the steps of taking textual data from the instructions and from the database and subjecting such textual data to analysis with respect to subject matter. Such analysis may comprise cross-referencing the textual content with respect to the corresponding textual content of an indexed reference text database having one or more subdivisions compatible therewith by subject matter. Following such step, the system then adopts modifications of the textual data adapted to achieve a degree of textual harmonisation for subject indexing and matching purposes.

The analysis step in relation to the textual data for achieving such harmonisation for indexing and matching purposes comprises both statistical text analysis by the statistical text analysis function 28 and linguistic cross-referencing with respect to the linguistic database 26. A step of morphology rule analysis is likewise applied by means of the morphology rules function 30.

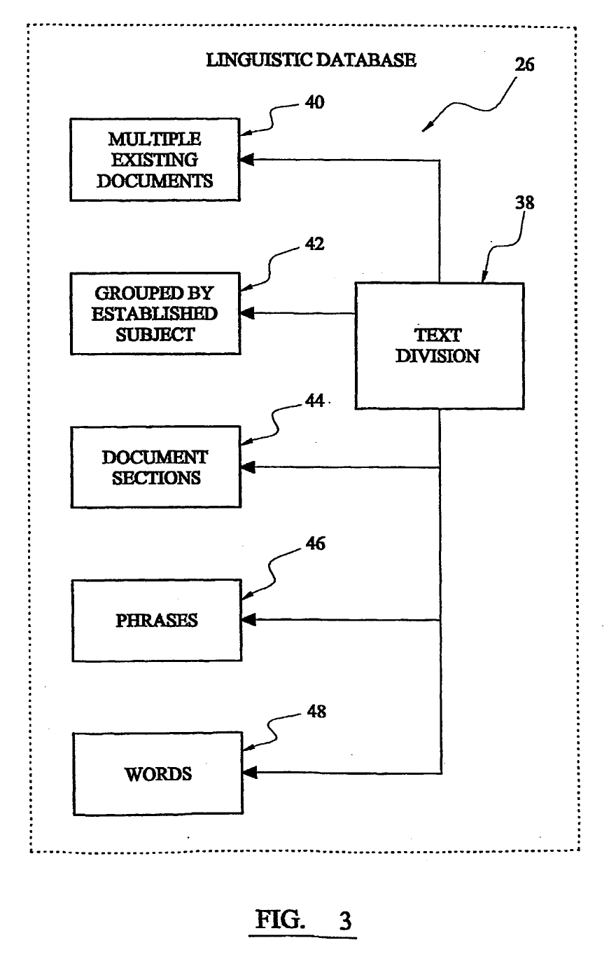

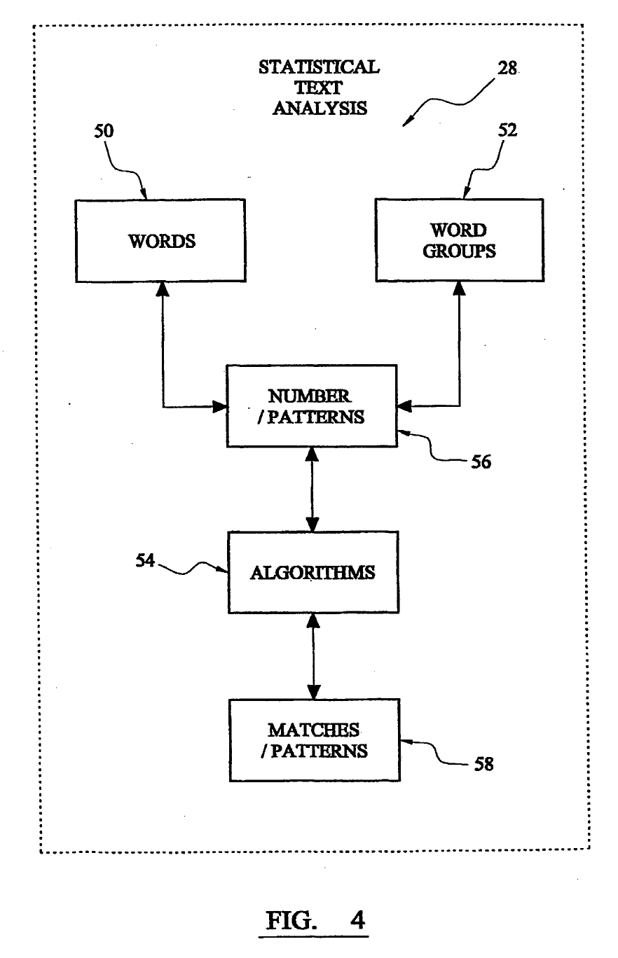

Turning now to the detailed functions of the linguistic database 26 and the statistical text analysis function, which are shown, respectively, in FIGS. 3 and 4 of the drawings, it needs to be observed first that these functions provide the above-discussed textual analysis with respect to textual content on the basis of the indicated word manipulation functions of FIGS. 3 and 4. Thus, in FIG. 3, the linguistic database 26 provides, in relation both to the speech instructions 32, the text instructions 34 and the database textual content of databases 12 to 20, a series of functions based largely upon the use of text division facility 38 having sub-strata or index divisions allocated to textual elements of differing magnitudes and identified in FIG. 3 as multiple existing documents section 40, subject groups 42, documents sections, 44 phrase sections 46, and word section or dictionary 48.

By this subdivision technique, which enables a unit-to-unit matching approach to be adopted in terms of textual elements of varying size, we have found that a useful improvement in matching a efficiency can be achieved.

The statistical text analysis function 28 of FIG. 4 adopts a non-comprehensional and numerically-based approach to the manipulation of words 50 and word groups 52 on the basis of allocated numerical identities which are manipulated by algorithms 54 by reference to the numbers and number patterns 56 thereby achieving matches and patterns 58 in a time-efficient manner which is not readily achievable on the basis of textual manipulation as such.

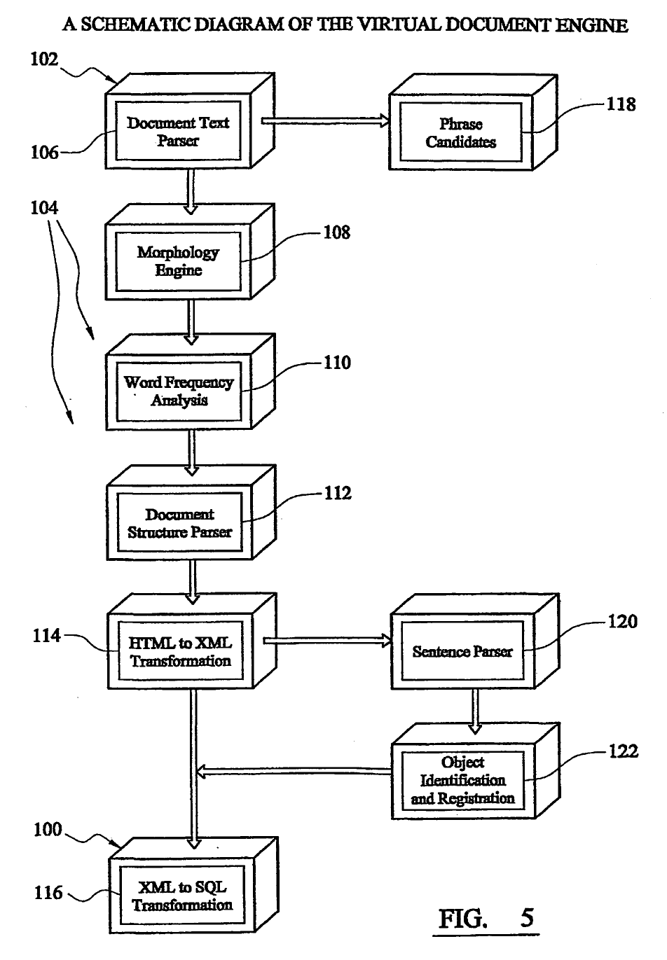

We turn now to the embodiments illustrated in FIGS. 5, 6 and 7 or the drawings which relate to functions of the system concerning an aspect of the embodiments of FIGS. 1 to 4 mentioned above, namely the facilitation of the search-to-database matching and retrieval function by the adoption of means facilitating the textual matching of the search instructions to the database content.

In the embodiments of FIGS. 5, 6 and 7, the approach is adopted of providing an index or reference portion of (or associated with) the database which is created from the database by a textual analysis or processing function in such a manner that the virtual document or index thus created is able to provide a significantly more detailed and precise basis for text matching with respect to search instructions.

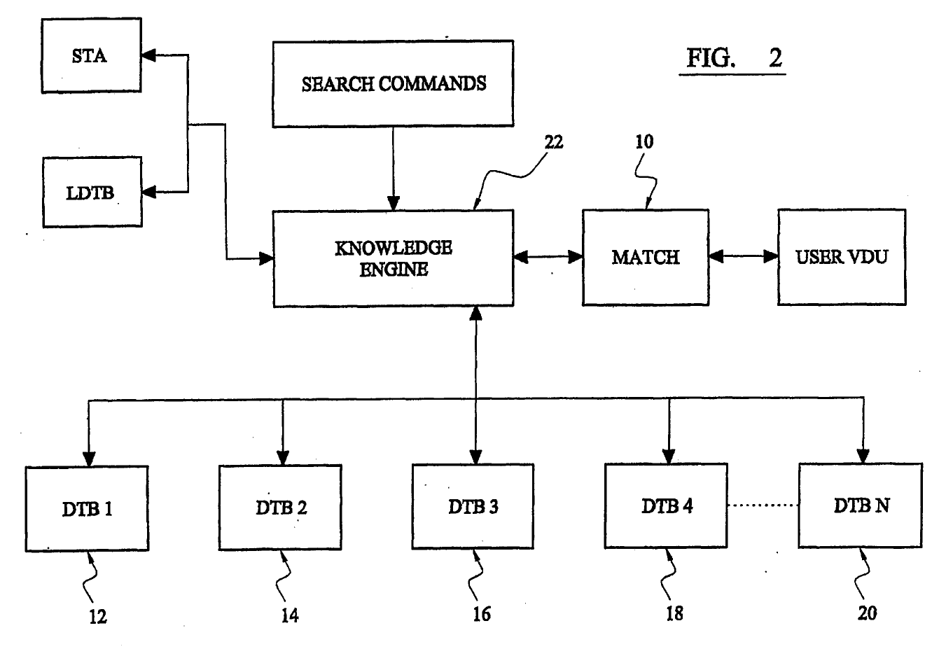

Accordingly, the embodiment of FIG. 5 shows the steps involved in the creation of a virtual document 100 starting from text 102 from one of the databases 12 to 20 of FIG. 2 which is to be subjected to a series of analytical steps identified generally at 104 to facilitate more precise textual matching with search instructions.

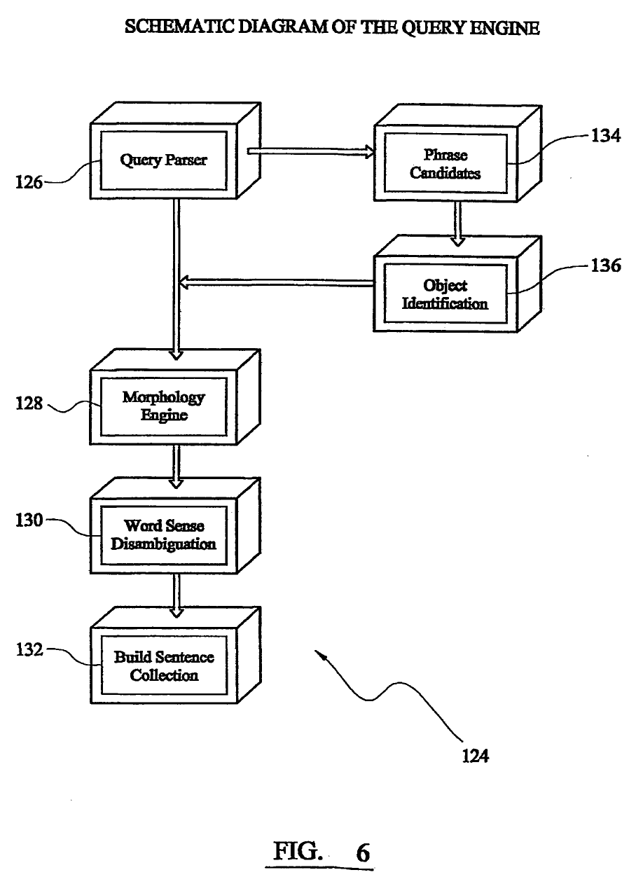

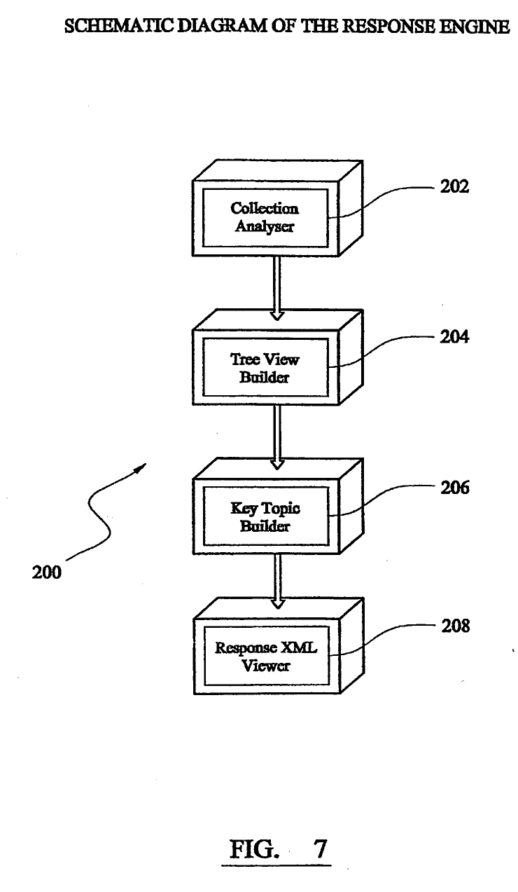

In FIG. 5, reference numerals 100 and 102 identify block-format data representations merely as a convenient visual device. These particular blocks also have labels in FIG. 5 referring to the analytical steps associated with the data/text in question, as discussed below. This convention for representation of data and functions is adopted merely for illustrative convenience. FIG. 5 shows the sequence of functions and steps applied to text and related documentation data in the production of a virtual document or index facility for database access purposes, whereas FIG. 6 shows, in a similar format, the related functions of a so-called query engine which provides textual analysis of the search instructions applied to the database, while FIG. 7 shows, likewise in a similar format, the corresponding related functions of a so-called response engine adapted to coordinate the provision of the text-matching data from the database to the required response address.

The analytical steps which are applied to the textual and/or other data from the relevant database include, as specifically identified in FIG. 5, document text parsing 106, application of morphology rules by morphology engine 108, word frequency analysis at 110, document structure parsing at 112, and language transformation at 114 and 116. Phrase candidate identification 118, and sentence parsing, and object identification and registration 122, provide sub-route functions, as shown, with respect to (respectively) the document text parser 106 and the language transformation step 104. These functions will be discussed in more detail below.

Considering first the document text parser, 106, this provides text handling in the HTML (hypertext markup language) format(from, for example, original documentation as a Word (RTM) file or a PDF (Adobe Acrobat, RTM) file). This step uses textual data in the data format of web pages.

The document text parsing function 106, examines at 118 the text for occurrences of nouns together, such being identified as “phrase candidates”. Such phrases are identified and their presence and identity integrated with the data (see below) resulting from analysis in relation to word frequency.

Turning now to the morphology engine 108, this applies a linguistic technique to individual words of the text by way of stem or morpheme identification, whereby a stem subtraction step provides identification of the remaining or word-ending element of the word in each case, which thus provides a means for the analysis of the linguistic word-relationships or morphology, for an evaluation of aspects of the text more closely related to its in-use meaning as a language element.

The step of word frequency analysis as identified at 110 is used in relation to a table of word stems which is constructed within the textual data used for construction of document or index 100, thereby to identify words which are in themselves significant as compared with words which, by themselves, do not provide sufficient information for categorisation or retrieval. As such, high frequency words do not necessarily provide enough information on their own to define an individual information unit.

Turning now to the document structure parser 112, and its related functions, the textual data is been transformed from HTML to XML (extensible markup language, an extension of HTML), and this process is caused to reflect textual subdivision into (for example) document/chapter/section format.

The relationship of document section indicia such as chapter headings in relation to document structure is handled by means of algorithms developed for the purpose to be able to integrate in a coherent way such indicia with a proper subdivision of the text into units of graded magnitude accordingly.

Further subdivision of the text into subject matter concepts within document sections is provided on a virtual basis (rather than by physical subdivision of the text) by word relation analysis based on evaluation of sentence constructions starting from sentence parsing.

The language transformation steps 114 and 116 effect a transformation from HTML to XML and thence to SQL (structured query language, a database interrogation language).

Following transformation from HTML to XML, sentence parser 120 identifies sentences within the text, each of which is recorded as a separate record, and within which the following step 122 of object identification is effected. Further details of object identification will now be described.

Thus, sentence parsing function 120 utilises algorithms applied to the text to identify sentences, each recorded as a separate record. We have developed algorithms for this purpose starting from text analysis systems using lexical databases such as Wordnet from Princeton University. Likewise, in function 122 for object identification words are parsed and tagged using XML tags according to word type.

Objects can be of a significant number of types, as discussed below. Objects represent the main body of search interest for database interrogation purposes, and thus require categorisation with considerable precision for effective and efficient text matching/identification and retrieval. Therefore, the discussion below provides some detail in relation to object identification.

Types of object include:

a) words present in the ignore list in relation to word type as resulting from the above parsing process;

b) words occurring with low frequency. Such words are linked to a chain of words related thereto as synonyms, whereby matching can be based on accepted synonyms as well as the word itself;

c) words occurring with high frequency. Such words usually have little value as such. The algorithm therefore forms an expanded version of the word by examining words before and after the high frequency word, thus developing phrases which are recorded for retrieval purposes as individual objects or word units. A word may be recorded therefore several times in combination with adjacent and related words, and such short phrases (two or more words) are all searched for retrieval purposes;

d) a word that fails a spell check or is recorded in “title case”. Such words usually identify a name. Names are recorded in the text dictionary as individual objects;

e) a word that appears to be a reference to another document or chapter or section, or even to a sentence. Such a word identifies a link to another piece of information. Such a word is recorded as a reference and an attempt is made to follow up the indicated link. If the link is to an object in the same section of the document, the two objects will be identified and retrieved. In this way the software can build chains between sentences in the same section of a database document;

f) registered names and classes. The above process identifies names from the text and these are recorded in the text dictionary. Once recorded, a name can be assigned to a class which defines a group of objects that share the same or similar properties. By allocating a name to a class of object, the name will inherit properties form the definition of the class. For example, in relation to automotive vehicles, a class of vehicle have properties of colour/engine size/price/top speed etc. Such a class and its properties are set up manually and a screen can be provided to enable a user to input property values for each such feature for an object within the class.

Property values for a class may be applied automatically. In the case above, colour could be restricted to a known range of available vehicle colours. Likewise price.

Tabulated data can be readily identified in HTML. For such data, a software process is applied to the tabulation to evaluate the structure of the table.

The above steps, all broadly relating to object identification, provide a detailed basis for production of a highly-indexed virtual document corresponding to a given database document and offering efficient subject matter retrieval facilities.

The set of words, phrases and names identified from the text of a given database document by the object identification process described above are then subjected to a self-organising mapping technique to generate categories of concepts which are sub grouped into concepts sharing common themes. This process is statistically based and using linguistic techniques, as described above in relation to FIGS. 1 and 3.

In the final step 116 of language transformation, the XML document is transformed to SQL for searching purposes.

Turning now to the query engine function 124 of FIG. 6, it will be noted that the functions of query parser 126, and morphology engine 128, and word sense disambiguation 130, and build sentence collection 132, with phrase candidates selection 134, and object identification 136 as laterally-related sub functions, all have some relationship to the functions discussed above in relation to FIG. 5. Indeed the overall structure of the query engine function of FIG. 6 is closely correlated to that of the virtual document engine of FIG. 5 in order to facilitate the effective and efficient matching of text for retrieval purposes.

Query parser 126 parses the incoming search instructions into individual words, and from these the phrase candidates selector 134 analyses the text for possible noun phrases which are tested against the dictionary without requiring exact matches.

Object identification function 136 identifies names and searches for matches with the dictionary name file, again without requiring exact matches.

In the morphology engine 128 words are reduced to their stems, and hyponyms are added, eg a search on fruit might be expanded to include searches for apples, oranges, bananas, etc. Hyponyms are available from a hyponym database they may be added to the search at a suitable stage if no matches are obtained.

The word sense disambiguation function 130 applies algorithms to the words to evaluate the sense of use of a word. We have developed such algorithms starting from available textual analysis systems. Synomyms are then added. Such additions enable more precise searching since such an approach is based on the sense of the word.

The build sentences collection function 132 serves to identify database sentences matching those of the search instructions or query.

FIG. 7 illustrates the response engine function 200 comprising collection analyser function 202, tree view builder function 204, key topic builder function 206 and response XML viewer 208.

These functions serve to provide for the user a presentation of retrieved data from the relevant databases in an organised format which is likely to be best matched to the requirements of the user. Thus, collection analyser function 202 evaluates the number of possible text matches at concept level together with the number of topics that contain possible matches so as to determine the appropriate method for display of the search result. Where concepts are returned that belong to different topics, the display shows the topics that the concepts belong to. User selection of a topic causes display of the concept contained within that topic. A low number of matches may cause display at concept level.

Tree view builder function 204 provides organisation of identified matches so as to allow the user to select the level of detail required. For example, a search response may generate two or three chapter objects as a response and the user may to look in more detail within one of these chapters and this can be achieved using the tree view. The display can zoom in at concept level within a section and within a chapter.

The key topic builder 206 produces from the returned collection of data matches, a list of key topics, these describe all concepts contained in the collection of matching text as gathered by the response engine.

The response XML viewer function enables user access to the XML transformation of the original document on the basis of the search findings.

Not shown in the drawings are an abstraction engine and an explorer engine. The abstraction engine is adapted to summarise text. A document section identified for reporting purposes could still contain a number of pages of text. The abstraction engine identifies key concepts within the text and allows the user to select the degree of summarisation required. A five hundred word document could be reduced to 100 words or even 250 words.

The explorer engine uses a statistical technique (Self Organising Map, SOM) that allows a graphic visualisation of the concept and categories of documents and sections of documents in an automatic manner. The SOM uses the objects registered in the dictionary to provide this visualisation, including phrases and names as identified by the virtual document engine.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A method for data management permitting selective access to a database by subject and/or data grouping, the method comprising:
a) providing at least one database to which access is to be provided by subject or data grouping;
b) providing data processing means adapted to provide access to said database;
c) providing access instruction means adapted to permit instructions to be provided to said data processing means for said access, and causing same to instruct said data processing means accordingly;
d) and causing said data processing means to match said instructions with data items stored in said database to permit said matched data items to be identified for retrieval;
wherein
e) said step of causing said access instruction means to instruct said data processing means being accompanied by the steps of data processing of said instructions and either then or previously of said database data or of a reference portion thereof to facilitate said matching of said instructions with said data items;
f) said data processing of said instructions and of said database data comprising the steps of:
i) taking textual data from said instructions and from said database;
ii) subjecting said textual data to analysis with respect to subject matter by a series of steps providing a degree of word sense disambiguation; and
g) and said steps being performed at least in part in relation to said data items stored in said database by reference to said textual data after said analysis with respect to subject matter.

2. A method according claim 1 characterised by the step of subjecting textual data from said instructions and/or from said database also to at least one step of morphology rule analysis by said data processing means and adapted to provide a preliminary or subsequent refinement step with respect to the textual content of said textual data.

3. A method according to claim 1 characterised by said step of subjecting said textual data to analysis with respect to subject matter being adapted to identify single concepts in said instructions and in said database and being adapted to seek matches there-between.

4. A method according to claim 3 characterised by said step of matching said instructions with said data items comprising identifying one or more text locations within said database where matches with respect of said single concept are located.

5. A method according to claim 1 characterised by said step of subjecting said textual data to analysis with respect to subject comprising use of algorithms adapted to determine a degree of the sense in which a word is used by reference to the context in which the word is used by analysis of adjacent words and/or word groups with which it is used.

6. A method according to claim 1 characterised by step of subjecting said textual data to analysis with respect of subject matter comprising use of algorithms adapted to determine a degree of the sense in which a word is used by reference to a database dictionary of synonyms and synonym sets whereby identification of word sense is not prevented variations in language use as between the instructions and the database.

7. A method according to claim 1 characterised by the step of establishing a reference or index database based on textual and other data from the original database and which is to form a searchable virtual database for subject matter identification and in which identified textual subject matter or concepts are stored in a compact data format.

8. A method for data management permitting selective access to a database by subject and/or data grouping, characterised by the step of data matching by reference to textual data subject matter.

9. A method according to claim 8 characterised by said step of providing instructions for data matching to selectively access the database.

10. A method according to claim 9 characterised by said step of subjecting said textual data to analysis with respect to subject matter being adapted to identify single concepts in said instructions and in said database and being adapted to seek matches there-between.

11. A method according to claim 10 characterised by said step of matching said instructions with said data items comprising identifying one or more text locations within said database where matches with respect of said single concept are located.

12. A method according to claim 9 characterised by said step of subjecting said textual data to analysis with respect to subject comprising use of algorithms adapted to determine a degree of the sense in which a word is used by reference to the context in which the word is used by analysis of adjacent words and/or word groups with which it is used.

13. A method according to claim 9 characterised by step of subjecting said textual data to analysis with respect of subject matter comprising use of algorithms adapted to determine a degree of the sense in which a word is used by reference to a database dictionary of synonyms and synonym sets whereby identification of word sense is not prevented variations in language use as between the instructions and the database.

14. A method according to claim 9 characterised by the step of establishing a reference or index database based on textual and other data from the original database and which is to form a searchable virtual database for subject matter identification and in which identified textual subject matter or concepts are stored in a compact data format.

15. A method according claim 9 characterised by the step of subjecting textual data from said instructions and/or from said database also to at least one step of morphology rule analysis by said data processing means and adapted to provide a preliminary or subsequent refinement step with respect to the textual content of said textual data.

16. A method for data management permitting selective access to a database by subject and/or data grouping, the method comprising:
a) providing at least one database to which access is to be provided by subject or data grouping;
b) providing data processing means adapted to provide access to said database;
c) providing access instruction means adapted to permit instructions to be provided to said data processing means for said access, and causing same to instruct said data processing means accordingly;
d) and causing said data processing means to match said instructions with data items stored in said database to permit said matched data items to be identified for retrieval;
characterised by
e) said step of causing said access instruction means to instruct said data processing means being accompanied by the steps of data processing of said instructions and either then or previously of said database data or of a reference portion thereof to facilitate said matching of said instructions with said data items;
f) said data processing of said instructions and of said database data comprising the steps of:
i) taking textual data from said instructions and from said database;
ii) subjecting said textual data to analysis with respect to subject matter by cross-referencing the textual content thereof with respect to the corresponding textual content of an indexed reference text database or lexical dictionary adapted to facilitate word sense disambiguation; and
iii) identifying a degree of limitation of word sense by reference to said additional textual data of said reference text database whereby, a degree of textual pre-analysis for subject indexing and matching purposes is provided.

17. A method according claim 16 characterised by the step of subjecting textual data from said instructions and/or from said database also to at least one step of morphology rule analysis by said data processing means and adapted to provide a preliminary or subsequent refinement step with respect to the textual content of said textual data.

18. A method according to claim 16 characterised by the step of subjecting textual data from said instructions also to at least one step of statistical text analysis by said data processing means and adapted to provide a preliminary or subsequent refinement step with respect to the textual content of said textual data.

19. A method for data management permitting selective access to a database by subject and/or data grouping characterised by the step of causing database access instruction means instructions to data processing means to be accompanied by the step of data processing of said instructions and either then or previously of said database or a reference portion thereof to facilitate said matching, said data processing comprising the steps of taking textual data from said instructions and from said database and subjecting said textual data to analysis by subject matter with cross-referencing of textual content with that of an indexed reference text database or lexical dictionary adapted to facilitate word sense disambiguation, and identifying, a degree of limitation of word sense by reference to said additional text of said reference text database whereby a degree of textual pre-analysis for subject indexing and matching purposes is provided.

20. A method according claim 19 characterised by the step of subjecting textual data from said instructions and/or from said database also to at least one step of morphology rule analysis by said data processing means and adapted to provide a preliminary or subsequent refinement step with respect to the textual content of said textual data.

21. A method for data management permitting selective access to a database by subject and/or data grouping, the method comprising:
a) providing at least one database to which access is to be provided by subject or data grouping;
b) providing data processing means adapted to provide access to said database;
c) providing access instruction means adapted to permit instructions to be provided to said data processing means for said access, and causing same to instruct said data processing means accordingly; and
d) causing said data processing means to match said instructions with data items stored in said database to permit said matched data items to be identified for retrieval;
characterised by
e) the step of subjecting textual data from said instructions and/or from said database also to at least one step of statistical textual analysis by said data processing means, in combination with at least one step of linguistic analysis by cross-referencing the textual data to a linguistic textual database, said statistical and linguistic text analysis steps being adapted to provide successive refinement steps with respect to the textual content of said textual data for matching purposes.

22. A method according claim 21 characterised by the step of subjecting textual data from said instructions and/or from said database also to at least one step of morphology rule analysis by said data processing means and adapted to provide a preliminary or subsequent refinement step with respect to the textual content of said textual data.

23. A method for data management permitting selective access to a database by subject and/or data grouping, the method comprising:
a) providing at least one database to which access is to be provided by subject or data grouping;
b) providing data processing means adapted to provide access to said database;
c) providing access instruction means adapted to permit instructions to be provided to said data processing means for said access, and causing same to instruct said data processing means accordingly;
d) and causing said data processing means to match said instructions with data items stored in said database to permit said matched data items to be identified for retrieval;
characterised by
e) said step of causing said access instruction means to instruct said data processing means being accompanied by the step of causing said data processing means to search a reference or index portion of or associated with said database to facilitate said matching of said instructions with data items;
f) said reference or index portion of or associated with said database having been prepared from said database data by a method comprising the steps of:
i) taking textual and/or other data from said database;
ii) subjecting said textual and/or other data to analysis with respect to the textual content thereof;
iii) adopting modifications and/or elements of said textual data resulting from said analysis for said reference or index, said modifications and/or elements being adapted to permit more precise textual matching with search instructions.

24. A method according to claim 23 characterised by said analysis of said textual data comprising text parsing.

25. A method according to claim 23 characterised by said step of analysis of said textual data comprising word frequency analysis.

26. A method according to claim 23 characterised by said analysis of said textual data comprising document structure parsing.

27. A method according claim 23 characterised by the step of subjecting textual data from said instructions and/or from said database also to at least one step of morphology rule analysis by said data processing means and adapted to provide a preliminary or subsequent refinement step with respect to the textual content of said textual data.

28. A method for data management permitting selective access to a database by subject and/or data grouping characterised by the step of causing database access instructions means instructions to data processing means to cause data processing means to search a reference or index portion of or associated with said database to facilitate said matching, said reference or index portion of or associated with said database having been prepared from database data by a method comprising subjecting said textual data to analysis with respect to textual content, and adopting modifications and/or elements of the textual data resulting from said analysis for said reference or index to permit more precise textual matching with search instructions.

29. A method according to claim 28 characterised by said analysis of said textual data comprising text parsing.

30. A method according to claim 28 characterised by said step of analysis of said textual data comprising word frequency analysis.

31. A method according to claim 28 characterised by said analysis of said textual data comprising document structure parsing.

32. A method according claim 28 characterised by the step of subjecting textual data from said instructions and/or from said database also to at least one step of morphology rule analysis by said data processing means and adapted to provide a preliminary or subsequent refinement step with respect to the textual content of said textual data.
